(19) United States
(12) Patent Application Publication
(10) Pub. No.: US 2023/0251914 A1
(43) Pub. Date: Aug. 10, 2023

(54) SUSTAINABILITY-AWARE DEVICE CONFIGURATION VISIBILITY AND MANAGEMENT

(71) Applicant: Microsoft Technology Licensing, LLC, Redmond, WA (US)

(72) Inventors: Scott Thomas CHAMBERLIN, Bellevue, WA (US); Kiersten Leigh SUTORIUS, Snohomish, WA (US); Sandeep PRABHAKAR, Bellevue, WA (US); Scott ROSOFF, Seattle, WA (US)

(73) Assignee: Microsoft Technology Licensing, LLC, Redmond, WA (US)

(21) Appl. No.: 17/722,022

(22) Filed: Apr. 15, 2022

Related U.S. Application Data
(60) Provisional application No. 63/308,247, filed on Feb. 9, 2022.

(51) Int. Cl. G06F 9/50; G06F 11/30; G06F 9/445; G06F 9/48

(52) U.S. Cl. CPC G06F 9/5094; G06F 11/3062; G06F 9/5005; G06F 9/44505; G06F 9/4893

(57) ABSTRACT

In examples, a device configuration is evaluated according to a set of conservation rules, such that one or more configuration recommendations may be generated. A configuration recommendation may be presented to a user of the computing device, such that the user may accept or reject the recommendation. If the recommendation is rejected, the recommendation may be presented to the user at a later time. In another example, a sustainability forecast may be obtained by the computing device, which may include estimated characteristics for an associated energy grid. The sustainability forecast may be presented to a user, thereby enabling the user to consider whether it may be preferable to use the computing device in one or more time periods that have a comparatively lower estimated environmental impact. A sustainability utilization metric may also be generated that is indicative of an estimated past environmental impact of the device.

### CROSS-REFERENCE TO RELATED APPLICATION

This application claims priority to U.S. Provisional Application No. 63/308,247, titled “Sustainability-Aware Device Configuration Visibility And Management,” filed on Feb. 9, 2022, the entire disclosure of which is hereby incorporated by reference in its entirety.

### BACKGROUND

A computing device may have a variety of configuration options that affect the behavior and associated resource utilization of the computing device. Further, the computing device may be used to perform a variety of computing tasks at the direction of the user. However, due to limited visibility into actual or estimated resource consumption associated with device usage and configuration, it may be difficult for the user to identify configurations and usage patterns that improve the environmental impact associated with use of the computing device.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to sustainability-aware device configuration visibility and management. In examples, a device configuration is evaluated according to a set of conservation rules, such that one or more configuration recommendations may be generated. In some instances, it may be determined not to generate a configuration recommendation, as may be the case when device utilization information indicates that the behavior of the computing device would not change if a configuration recommendation was implemented. A configuration recommendation may be presented to a user of the computing device, such that the user may accept or reject the recommendation. If the recommendation is rejected, the recommendation may be presented to the user at a later time.

In another example, a sustainability forecast may be obtained by the computing device. The sustainability forecast may include one or more estimated characteristics for an energy grid associated with the computing device. At least a part of the sustainability forecast may be presented to a user of the device, thereby enabling the user to consider whether it may be preferable to use the computing device in one or more time periods as compared to other time periods (e.g., that have a comparatively lower estimated environmental impact). Additionally, the sustainability forecast may be used to generate a sustainability utilization metric that is indicative of an estimated past environmental impact of the device. The sustainability utilization metric may similarly be presented to a user of the computing device, thereby providing visibility into the estimated impact of operating the computing device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for device configuration visibility and management according to aspects described herein.

FIG. 2 illustrates an overview of an example method for evaluating a device configuration according to a set of conservation rules to generate a configuration recommendation.

FIG. 3 illustrates an overview of an example method for presenting and optionally applying a configuration recommendation according to aspects described herein.

FIG. 4 illustrates an overview of an example method for presenting sustainability information and generating a device utilization metric based on the sustainability information.

FIGS. 5A-5C illustrate overviews of example user interfaces with which sustainability information, a device utilization metric, and/or one or more configuration recommendations may be presented to a user.

FIG. 6 is a block diagram illustrating example physical components of a computing device with which aspects of the disclosure may be practiced.

FIGS. 7A and 7B are simplified block diagrams of a mobile computing device with which aspects of the present disclosure may be practiced.

FIG. 8 is a simplified block diagram of a distributed computing system in which aspects of the present disclosure may be practiced.

FIG. 9 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, various aspects of a device may be user-configurable, including, but not limited to, screen brightness, a screen dim and/or turn off timer, a device sleep timer, and a device hibernate timer, among other examples. A computing device may be preconfigured with a set of default configuration options, which may be modified by a system integrator and/or an end user. As another example, a user may temporarily modify one or more configuration options and may later forget to revert the configuration options to an earlier, more sustainable or environmental friendly setting. Further, a user may perform any of a variety of computing tasks using the computing device. However, the environmental impact of modifying such configuration options and of a user's usage pattern may not be readily apparent to the user, for example as a result of limited visibility into actual or estimated resource consumption of the computing device.

Accordingly, aspects of the present application relate to sustainability-aware device configuration visibility and management. In examples, a device configuration may be evaluated according to a set of conservation rules to generate one or more configuration recommendations for presentation to a user. If the user accepts a configuration recommendation, the computing device may be reconfigured accordingly, thereby reducing or altering an environmental impact associated with the computing device.

For example, a device configuration (e.g., including one or more configuration options) may be determined based on telemetry data associated with the computing device. The telemetry data may include an indication of one or more configuration options for the computing device. In instances where a user has opted-in, the telemetry data may include device utilization information, such one or more periods of inactivity and/or an average or peak processor utilization or system load for one or more periods of activity. In some examples, the telemetry data includes a sustainability utilization metric for one or more periods of time, as may be generated according to aspects described herein.

The telemetry data may be processed according to a set of conservation rules, which may generate a set of configuration recommendations based on the device configuration and, in some examples, utilization information associated therewith. For example, a conservation rule may evaluate a configuration option of the device as compared to a recommended configuration option specified by the conservation rule, such that a configuration difference between the device configuration option and the recommended configuration option may be determined. In some examples, the difference may be evaluated based on a predetermined threshold, such that a difference below the predetermined threshold may cause the conservation rule to determine to not generate a configuration recommendation associated with the device configuration option.

It will be appreciated that a conservation rule may evaluate multiple configuration options in other examples. For instance, an aggregate and/or weighted difference may be determined for a set of device configuration options (e.g., relating to a combination of screen brightness, a display turn off timer, and a device sleep timer), such that, depending on the combination of device configuration options, it may be determined to generate an associated recommendation. As an example, if the display brightness is higher than a recommended brightness option specified by the conservation rule but the display turn off timer is quicker than a recommended timeout option, it may be determined not to generate a configuration recommendation. As another example, if the display brightness is lower than the recommended brightness option but the display turn off timer is set to ‘never,’ a configuration recommendation may be generated to enable the display turn off timer (e.g., to a value of 15 or 30 minutes). In a further example, it may be determined that a workload typically runs at a time period (e.g., which may be typically associated with an increased environmental impact), such that a configuration recommendation may be generated to shift the workload to a different time period.

As another example, a conservation rule may evaluate utilization information when available, such that it may be determined whether a configuration recommendation, if accepted, would affect the resource utilization of a computing device. For example, a device configuration option may indicate that a sleep timer of the device is set to ‘never,’ but the utilization information may indicate that the device would rarely or never enter sleep even if the sleep timer was enabled. Thus, a configuration recommendation may not be generated or may be generated to recommend a more permissive configuration (e.g., having a longer timeout value, having a higher brightness value) in instances where the result of implementing the recommendation would be determined to have little to no effect (e.g., based on a comparison between historical utilization and estimated utilization in view of a predetermined threshold).

In examples, the set of conservation rules with which telemetry data is evaluated may be device-specific and/or may change over time. For example, a set of conservation rules may be determined according to device capabilities, such that different devices (e.g., with different capabilities) may have different associated default and/or recommended options. As another example, organizational, local, regional, or national guidelines, recommendations, and/or requirements may change, such that a set of conservation rules may be updated to reflect such changes. Further, while example configuration options and associated conservation rules and resulting recommendations are described herein, it will be appreciated that any of a variety of alternative and/or additional examples of such aspects may be used in other examples.

A determined configuration recommendation may be presented to a user of a computing device using a variety of techniques. For example, a configuration recommendation may be displayed as part of a settings user interface of the computing device. In some instances, the configuration recommendation is presented in association with a configuration option to which the recommendation pertains. If a user actuates the configuration recommendation, the associated configuration option may automatically be updated according to the approved configuration recommendation. In examples, multiple configuration options may be modified as a result of the user accepting a set of configuration recommendations.

As another example, a configuration recommendation may be presented on a lock screen of the computing device or as a notification. For example, the configuration recommendation may be presented after a scenario in which the configuration recommendation would have resulted in different device behavior, such as after a user returns to the computing device after a period of time during which the computing device would have otherwise entered a sleep state.

A user may ignore or dismiss a configuration recommendation. For example, the user may actuate a control element to ignore the configuration recommendation, the user may leave the screen at which the configuration recommendation is presented (e.g., the lock screen or the settings user interface), or the user may permit a notification to timeout at which point the notification will disappear and the recommendation may be determined to have been dismissed or ignored. In such an example, the configuration recommendation may be retained for subsequent presentation to the user, for example using a similar and/or a different presentation mechanism. As an example, a recommendation may first be presented on a user's lock screen, then as a notification, and ultimately may reside as a recommendation displayed in the settings user interface.

While example presentation mechanisms are described, it will be appreciated that any of a variety of alternative and/or additional techniques may be used in other examples. Further, it will be appreciated that, in some examples, a configuration recommendation may be automatically applied, as may be the case when a conservation rule identifies a configuration change that is associated with a requirement or mandate, among other examples. As an example, an administrator may specify a conservation rule on behalf of a group of users.

In another example, a sustainability forecast may be obtained by the computing device, where the sustainability forecast includes one or more forecasted energy characteristics for an energy grid associated with the computing device (e.g., as may be determined by a device location). For example, the sustainability forecast may be for a predefined time period (e.g., a 24-hour or 7-day period) and may have a set of entries according to a predefined granularity (e.g., minutely, quarter-hourly, hourly, or daily). Example energy characteristics include, but are not limited to, a carbon (and/or other resource) intensity associated with the mixture of energy generation for the energy grid and what percentage of the available energy is generated by renewable sources.

The sustainability forecast may be presented to a user of the computing device (e.g., as part of a settings user interface, as a scheduled notification, or in response to identifying increased resource utilization of the computing device), thereby enabling the user to consider whether a task could be performed during a time period having a reduced environmental impact. For example, the sustainability forecast may be displayed on a lock screen of a computing device prior in the morning (e.g., prior to use by a user).

As another example, a notification may be generated when high resource utilization of a computing device is identified (e.g., after a predetermined amount of time has elapsed since resource utilization has exceeded a predetermined threshold), such that the user may be reminded that an alternate time may have a lower estimated environmental impact. Similarly, a notification including information associated with a sustainability forecast may be presented in an instance where it is determined that an application that is currently executing has not received user input for a predetermined amount of time, as may be the case when the user has forgotten that the application was left open in the background.

The sustainability forecast may be used to generate a sustainability utilization metric for a computing device, based on determined device utilization in combination with an associated sustainability forecast entry. In an example where the sustainability forecast includes hourly entries, a device energy consumption for the hour may be used in combination with the hourly sustainability forecast entry to generate an estimated sustainability utilization metric for that hour. Multiple hourly sustainability utilization metrics may be combined to yield a daily total sustainability utilization metric and/or a daily average sustainability utilization metric, among other examples. It will be appreciated that similar techniques may be used for any of a variety of other granularities, such as based on minutely or quarter-hourly data.

As noted above, a sustainability utilization metric may be provided as part of device utilization information included within telemetry data according to aspects described herein. In another example, an indication of a sustainability utilization metric may be presented to a user of the computing device, for example in conjunction with or using similar techniques to a sustainability forecast as described above (e.g., thereby providing a display having both a historical and forward-looking portion) or as a daily and/or weekly summary of device utilization, among other examples.

Thus, aspects of the present disclosure provide increased visibility into resource utilization and associated sustainability considerations associated with device configuration and usage patterns. It will be appreciated that the disclosed techniques may be applied to any of a variety of computing devices, including, but not limited to, mobile computing devices, tablet computing devices, laptop computing devices, desktop computing devices, server computing devices, and Internet-of-Things (IoT) computing devices. For example, a configuration recommendation for an IoT computing device may be provided to another computing device for display to a user of the configuration recommendation may be automatically applied in other examples. As another example, a sustainability utilization metric associated with an IoT or peripheral device may be provided to another computing device for presentation to a user. In some instances, a configuration recommendation and/or a sustainability utilization metric may be based at least in part on one or more associated other devices. Additionally, a configuration recommendation may be generated for a computing device based on an associated peripheral device, such as a monitor or an external hard drive, among other examples.

While examples are described with respect to an energy grid, it will be appreciated that similar techniques may be used for alternate energy sources. For example, an individual or an organization may operate a generator or utilize solar energy to obtain at least a part of the energy used by a computing device. In such examples, a device may be configured to incorporate these and other energy sources into a sustainability forecast, for example to override sustainability information associated with an energy grid and/or to generate a more accurate sustainability utilization metric.

As another example, an organization may operate a sustainability platform that integrates alternate energy sources into sustainability information obtained from other sources (e.g., a data provider and/or another sustainability platform). Computing devices of the organization may obtain sustainability information from the organizational sustainability platform (e.g., when the computing device is located on the premise of the organization. Similar techniques may be applied for residential settings or cities, among other examples. One or more configuration rules may be specified by an organization. Similarly, sustainability utilization metrics may be aggregated for the organization, such that the effectiveness of one or more configuration rules may be evaluated.

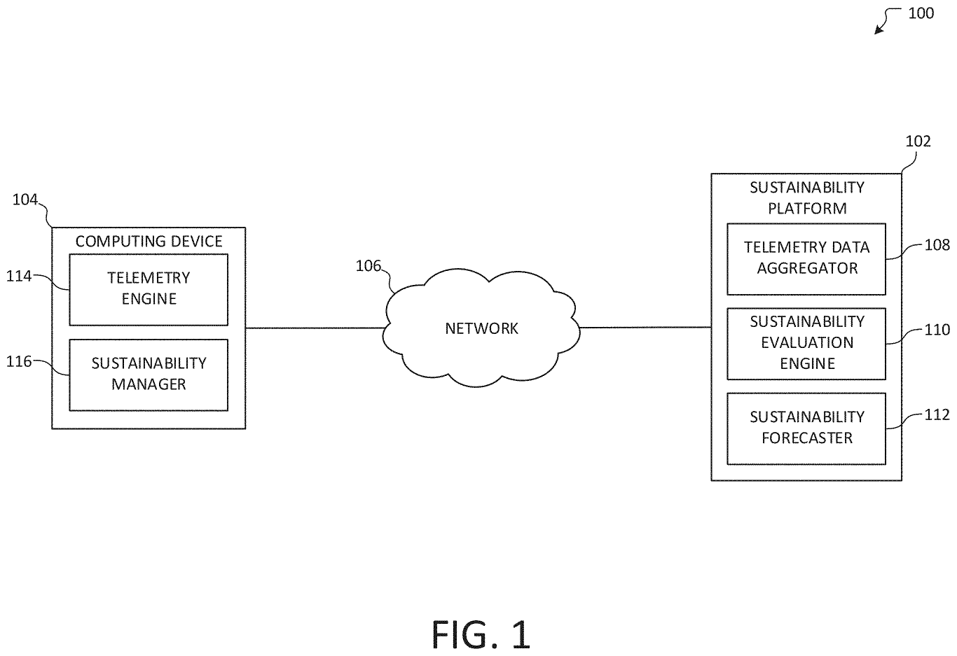

FIG. 1 illustrates an overview of an example system 100 for device configuration visibility and management according to aspects described herein. As illustrated, system 100 includes sustainability platform 102, computing device 104, and network 106. Sustainability platform 102 and computing device 104 are illustrated as communicating via network 106, which may comprise a local area network, a wireless network, or the Internet, or any combination thereof, among other examples.

As illustrated, sustainability platform 102 includes telemetry data aggregator 108, sustainability evaluation engine 110, and sustainability forecaster 112. In examples, aspects of sustainability platform 102 may be included as part of any of a variety of services or other platforms, such as part of an update service or a diagnostics platform.

Telemetry data aggregator 108 may obtain telemetry data from one or more computing devices (e.g., computing device 104). In examples, the telemetry data includes an indication of one or more configuration options associated with a computing device and, in instances where a user has opted in, utilization information of the computing device. The telemetry data may be anonymized, such that the configuration options and/or utilization information are associated with a unique identifier of the computing device. Telemetry data obtained by telemetry data aggregator 108 may be stored for access by or otherwise provided to sustainability evaluation engine 110.

In examples, sustainability evaluation engine 110 processes telemetry data according to a set of conservation rules as described above. For example, sustainability evaluation engine 110 may determine a set of conservation rules based at least in part on a device type (e.g., mobile device, tablet, laptop, or desktop) and/or a device model, among other examples. Sustainability evaluation engine 110 may identify configuration options and/or utilization information associated with a unique identifier, such that the identified configuration options and/or utilization information are processed according to the set of identified sustainability rules accordingly. In examples, sustainability evaluation engine 110 generates one or more configuration recommendations, as may be the case when it is determined that a device configuration option differs from a recommended configuration option (e.g., by a predetermined difference threshold). The determined set of configuration recommendations may be provided to the computing device or may be associated with the unique identifier of the computing device, such that the computing device may request the generated recommendations from sustainability platform 102. As noted above, one or more configuration recommendations may have an associated indication that they are required, such that they may be automatically applied by the computing device.

Sustainability engine 110 may process telemetry data to evaluate the effectiveness of one or more configuration recommendations and/or to generate, update, or remove conservation rules, among other examples. For example, sustainability platform 110 may compare telemetry data for a given device or group of devices to historical telemetry data to determine an associated difference. In instances where the difference does not exceed a predetermined threshold (e.g., a goal or target improvement), a conservation rule may be updated so as to cause the configuration of associated devices to be updated accordingly. As another example, sustainability evaluation engine 110 may process the telemetry data to generate a sustainability utilization metric for a set of devices (e.g., in association with an organization, a region, or a type of device).

Sustainability platform 102 also includes sustainability forecaster 112, which may provide a sustainability forecast to a computing device. For example, a sustainability forecast request may be received from a computing device. A location may be determined for the request, for example based on a location included therein or based on geolocation of an Internet Protocol (IP) address associated therewith. The sustainability forecast may be identified based on the determined location and provided in response to the request. In examples, the sustainability forecast includes a set of entries indicating one or more estimated energy characteristics for an energy grid associated with the determined location.

System 100 also includes computing device 104, which may be any of a variety of devices, including, but not limited to, a mobile computing device, a tablet computing device, a laptop computing device, a desktop computing device, a server computing device, or an IoT computing device. As illustrated, computing device 104 includes telemetry engine 114 and sustainability manager 116.

Telemetry engine 114 generates telemetry data, which may be provided to sustainability platform 102 as described herein. For example, telemetry engine 114 may obtain a set of device configuration options and/or utilization information associated with computing device 104. In examples, telemetry engine 114 is included as part of an operating system and/or an application of computing device 104, among other examples. As another example, telemetry engine 114 may aggregate telemetry data from or otherwise associated with multiple applications, services, and/or other aspects of computing device 104.

Sustainability manager 116 may obtain one or more configuration recommendations from sustainability platform 102. In examples, sustainability manager 116 presents a configuration option for user consideration, for example as a notification, via a lock screen, or in a settings user interface, among other examples. In some instances, sustainability manager 116 is included as part of an operating system or an application executing on computing device 104. For example, sustainability manager 116 may be a background service and/or may be accessible via a settings application of computing device 104. In instances where a user accepts a configuration recommendation, sustainability manager 116 may configure computing device 104 according to the accepted configuration recommendation. By contrast, if a user declines or ignores the configuration recommendation, sustainability manager 116 may remind the user of the configuration recommendation at a later time.

In examples, sustainability manager 116 obtains a sustainability forecast from sustainability platform 102 (e.g., as may be provided by sustainability forecaster 112). Accordingly, sustainability manager 116 may present at least a part of the obtained sustainability forecast to a user according to aspects described herein. In some instances, sustainability manager 116 generates a sustainability utilization metric based on an obtained sustainability forecast. For example, sustainability manager 116 may determine a device energy consumption for a time period and use the determined energy consumption in association with a corresponding entry of the sustainability forecast to generate an estimated sustainability utilization metric for that time period.

As noted above, a generated sustainability utilization metric may be included in telemetry data for computing device 104 that is generated by telemetry engine 114. In another example, an indication of a generated sustainability utilization metric may be presented to a user, for example as a notification, on a lock screen, or via a settings user interface, among other examples. In some instances, sustainability manager 116 may identify an application that exhibits a resource utilization among a predetermined metric, such that a notification may be generated to remind the user that the application is still executing and/or ask if the user would like to suspend execution until a time having a lower estimated environmental impact according to the sustainability forecast. As another example, execution may be suspended or terminated automatically (e.g., with or without such a notification).

While system 100 is illustrated as having a single sustainability platform 102 and a single computing device 104, it will be appreciated that any number of sustainability platforms and/or computing devices may be used in other examples. As an example, a sustainability platform may have an associated region, such that sustainability forecast requests received by the sustainability platform are assumed to be for the associated region and may be processed accordingly. In some instances, computing device 104 includes some or all of the functionality discussed above with respect to sustainability platform 102, such that a set of conservation rules may be processed local to the device. For instance, the conservation rules may be used to evaluate telemetry data (e.g., similar to sustainability evaluation engine 110) and/or any of a variety of other aspects of a device (e.g., configuration options and/or attached or associated devices). As another example, some aspects of telemetry engine 114 and/or sustainability manager 116 may be performed by a first device, while a second device performs other aspects, as may be the case when a peripheral device generates telemetry data that is provided by a laptop computing device or a configuration recommendation is received by a mobile computing device for application to an IoT device, among other examples. Similarly, a sustainability utilization metric may be generated for any number of devices. For example, a sustainability utilization metric may be generated for a computing device and one or more associated peripheral devices (e.g., a workstation sustainability metric), or for all devices associated with a user (e.g., a user sustainability metric), among other examples.

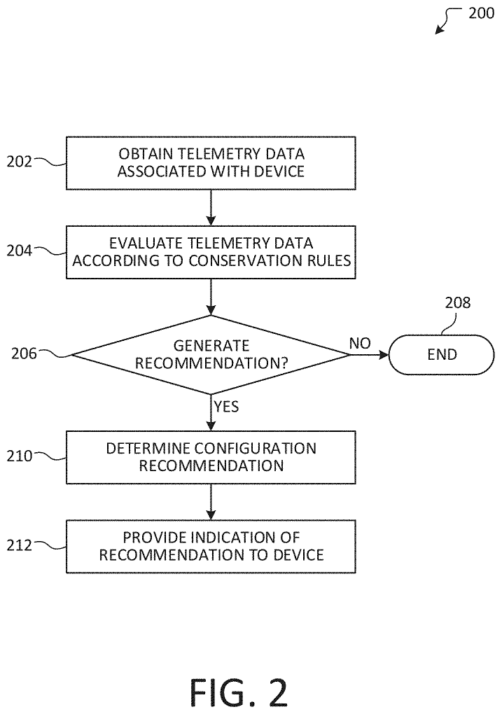

FIG. 2 illustrates an overview of an example method 200 for evaluating a device configuration according to a set of conservation rules to generate a configuration recommendation. In examples, aspects of method 200 are performed by a sustainability platform, such as sustainability platform 102 discussed above with respect to FIG. 1. For example, a telemetry data aggregator and/or a sustainability evaluation engine may perform such aspects, such as telemetry data aggregator 108 and/or sustainability evaluation engine 110.

Method 200 begins at operation 202, where telemetry data associated with a device is obtained. For example, the telemetry data may be provided by the device or may be obtained from the device in response to a request for the telemetry data. As discussed above, the telemetry data may include a set of device configuration options and, in instances where a user has opted in, device utilization information.

At operation 204, the telemetry data is processed according to a set of conservation rules. In examples, aspects of operation 204 are performed by a sustainability evaluation engine, such as sustainability evaluation engine 110 discussed above with respect to FIG. 1. In some instances, operation 204 includes determining a set of sustainability rules based on a device type and/or device model, among other examples. As noted above, a sustainability rule may evaluate a device configuration option based on a recommended configuration option and/or may evaluate device utilization information to determine a configuration recommendation. As another example, a conservation rule may determine not to generate a configuration recommendation, as may be the case when it is determined that a configuration recommendation that would otherwise be provided (e.g., absent utilization information or with different utilization information) is unlikely to have an effect for that specific device.

At determination 206, it is determined whether a conservation rule indicates that a configuration recommendation should be generated. In examples, multiple conservation rules may indicate that multiple associated configuration recommendations should be generated. If it is determined that a recommendation should not be generated, flow branches “NO” and terminates at operation 208.

However, if it is instead determined to generate a configuration recommendation, flow branches “YES” to operation 210, where a configuration recommendation is determined. As an example, at least a part of a set of conservation rules may be hierarchical, such that the last rule in the hierarchy that is satisfied has an associated configuration recommendation. As another example, each conservation rule of a set of conservation rules may have an associated configuration recommendation when the conservation rule is satisfied, such that operation 210 comprises aggregating the set of configuration recommendations and/or resolving conflicts (e.g., according to an associated priority or based on which conservation rule has the largest impact on resource utilization of the computing device). Thus, it will be appreciated that any of a variety of techniques may be used to determine one or more configuration recommendations at operation 210.

Flow progresses to operation 212, where an indication of the configuration recommendation is provided to the device. In examples, a set of configuration recommendations are provided to the computing device. As another example, the computing device may periodically communicate (e.g., to provide telemetry data), such that the configuration recommendations may be provided in association with a response to a periodic communication by the device. For example, operation 212 may comprise storing the recommendations with an associated device identifier, such that the device identifier may later be used to retrieve and provide the recommendations accordingly. Method 200 terminates at operation 212.

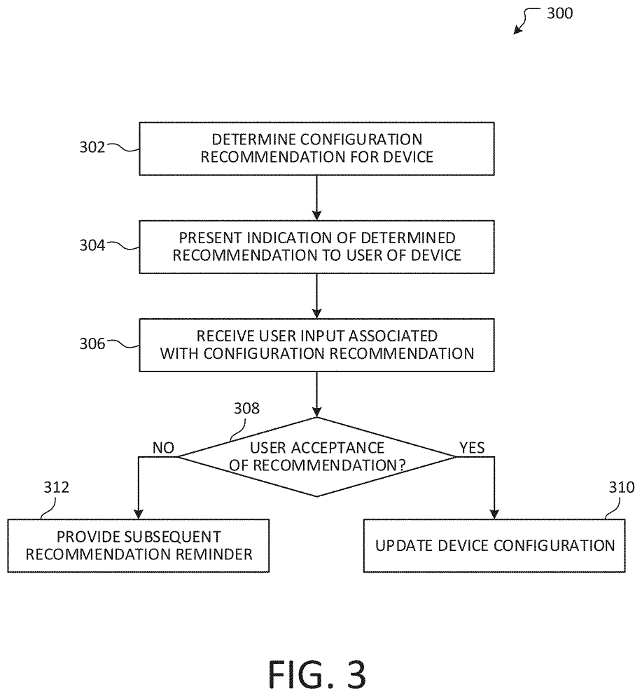

FIG. 3 illustrates an overview of an example method for presenting and optionally applying a configuration recommendation according to aspects described herein. In examples, aspects of method 300 are performed by a computing device, such as computing device 104 discussed above with respect to FIG. 1. For example, a telemetry engine and/or a sustainability manager may perform such aspects, such as telemetry engine 114 and/or sustainability manager 116.

Method 300 begins at operation 302, where a configuration recommendation is determined for the device. In examples, operation 302 comprises obtaining the configuration recommendation from a sustainability platform (e.g., sustainability platform 102 in FIG. 1), as may have performed aspects of method 200 discussed above with respect to FIG. 2. In other examples, operation 302 may comprise processing telemetry data of the device according to a set of conservation rules (e.g., as may be obtained from the sustainability platform), aspects of which may be similar to operations 204-210 discussed above with respect to method 200 and are therefore not necessarily re-described below in detail. For example, the computing device may include a sustainability evaluation engine, similar to sustainability evaluation engine 110 in FIG. 1.

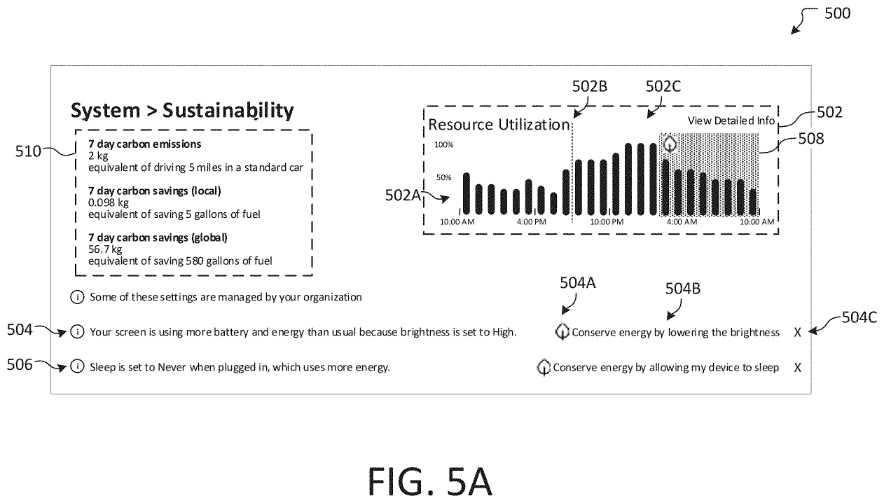

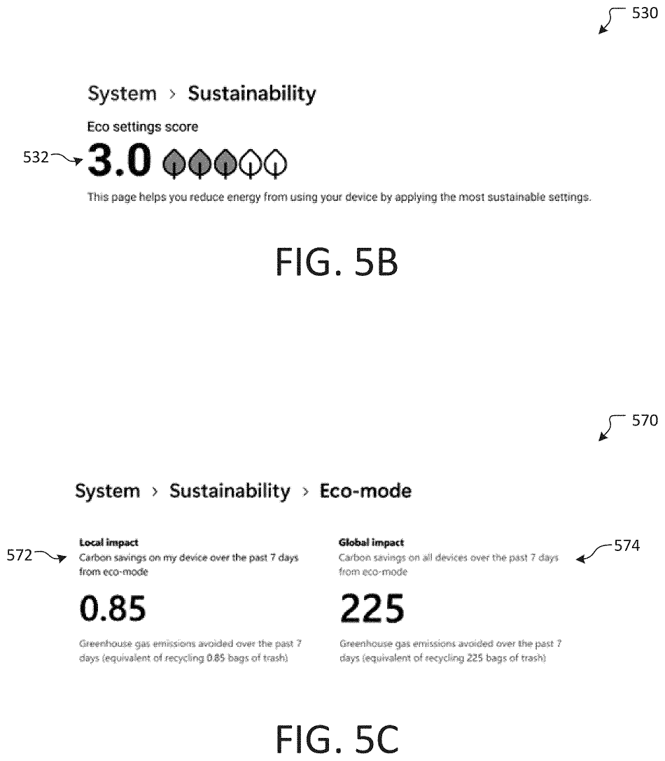

Flow progresses to operation 304, where an indication of a determined configuration recommendation is presented to a user of the computing device. As noted above, a configuration recommendation may be displayed as part of a settings user interface, on a lock screen, or as a notification, among other examples. Examples of such aspects are described below with respect to user interface 500 of FIG. 5.

At operation 306, user input associated with the configuration recommendation is received. For example, the user input may comprise actuation of one or more user interface elements that were presented at operation 304, including an accept button or a reject button. In another example, the absence of user input for a predetermined amount of time may be identified as user input associated with the configuration recommendation, and may be determined to indicate acceptance or rejection of the configuration recommendation.

Moving to determination 308, it is determined whether the user input received at operation 306 indicates user acceptance of the configuration recommendation. For example, actuation of an accept button may be determined to indicate acceptance, while an absence of user input or an actuation of a reject button may be determined to indicate rejection of the configuration recommendation. While example user experience aspects are described, it will be appreciated that a recommendation may be presented using any of a variety of techniques, each of which may have additional or alternative associated user inputs indicative of acceptance and/or rejection of a recommendation.

If it is determined that the user has accepted the configuration recommendation, flow branches “YES” to operation 310, where the configuration of the device is updated accordingly. For example, one or more configuration options of the computing device may be updated according to the accepted configuration recommendation. In examples, the configuration recommendation includes a portion that may be executed, parsed, or otherwise processed to modify one or more configuration options of the device. By contrast, if it is instead determined that the user did not accept the configuration recommendation, flow branches “NO” to operation 312, where a subsequent recommendation reminder may be presented. It will be appreciated that the subsequent reminder may be presented using any of a variety of presentation mechanisms, which may be similar to or different from the indication presented at operation 304.

While method 300 is described in an example where either operation 310 or operation 312 is performed, it will be appreciated that similar techniques may be used to process multiple configuration recommendations, such that a user may accept a subset of configuration recommendations. In such an example, operations 310 and 312 may both be performed (e.g., such that either operation 310 or operation 312 with respect to a given configuration recommendation). In another example, a configuration recommendation may be applied without performing operations 304-308 (e.g., in an instance where the recommendation is required). Method 300 terminates at operation 310 and/or operation 312.

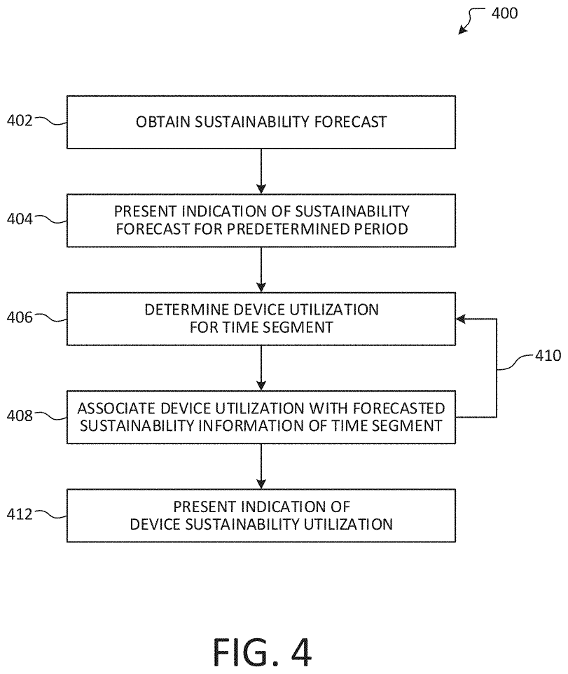

FIG. 4 illustrates an overview of an example method 400 for presenting sustainability information and generating a device utilization metric based on the sustainability information. In examples, aspects of method 400 are performed by a computing device, such as computing device 104 discussed above with respect to FIG. 1. For example, a sustainability manager may perform such aspects, such as sustainability manager 116.

Method 400 begins at operation 402, where a sustainability forecast is obtained. For example, the sustainability forecast may be obtained from a sustainability platform (e.g., sustainability platform 102 in FIG. 1), as may have been generated by a sustainability forecaster (e.g., sustainability forecaster 112). The sustainability forecast may include a set of entries (e.g., on a quarter-hourly or hourly basis), each having one or more associated forecasted characteristics for an energy grid. In examples, the sustainability forecast is obtained as a result of providing a sustainability forecast request to the sustainability platform. The request may include an indication of a location of the computing device or the sustainability platform may determine a location for the computing device based on an IP address of the request, among other examples.

Flow progresses to operation 404, where an indication of the sustainability forecast for a predetermined period is presented. In examples, operation 404 may be omitted, as may be the case when a user does not view a settings user interface via which the indication may be presented. As another example, operation 404 may comprise generating a notification or other message, thereby presenting an indication of the forecast in the absence of explicit user input.

A graphical representation may be presented for an upcoming period of time, such as for the next eight hours, for the next 24 hours or for the next seven days, among other examples. The graphical representation may include a graph or other visualization indicating relative one or more relative changes in energy characteristics over time, thereby enabling a user to consider whether one or more times may be preferable for using the computing device so as to reduce an associated environmental impact.

An example graphical representation is discussed below with respect to FIG. 5, but it will be appreciated that any of a variety of techniques may be used to present a forecast according to aspects described herein. In some instances, a user may manipulate the representation to change the time period (e.g., the granularity with which the information is presented and/or an associated range of times). As another example, a user may change an environmental characteristic for which a visualization is generated or may select a set of environmental characteristics.

At operation 406, a device utilization is determined for a time segment of the sustainability forecast. For example, operation 406 may comprise evaluating device energy consumption for a time segment corresponding to an entry of the sustainability forecast. The energy consumption may be total device power consumption or processor power consumption, among other examples. In some examples, operation 406 may evaluate utilization for the device overall or in association with one or more processes or other functionality of the device, among other examples.

Moving to operation 408, the device utilization determined at operation 406 is associated with forecasted sustainability information of the time segment. For example, device energy consumption may be associated with one or more energy characteristics for a forecast entry, thereby providing an estimate for an environmental impact of the computing device, which is referred to herein as a sustainability utilization metric. For example, if the sustainability forecast includes hourly entries, a device energy consumption for the hour may be determined at operation 406 used in combination with the hourly sustainability forecast entry at operation 408 to generate an estimated sustainability utilization metric for that hour.

Arrow 410 is provided to illustrate that flow loops between operations 406 and 408 to generate any number of sustainability utilization metrics for the computing device according to any number of time segments. For example, a sustainability utilization metric may be generated on a quarter-hourly basis, on an hourly basis, and/or on a daily basis. In examples, multiple sustainability utilization metrics may be aggregated, for example to combine multiple quarter-hourly metrics into an hourly metric or multiple hourly metrics into a daily metric.

Eventually, method 400 progresses to operation 412, where an indication of device sustainability utilization is presented. For example, one or more metrics generated as a result of performing operations 406-408 may be presented. The metrics may be presented as part of a settings user interface or as a notification, among other examples. For example, a notification may be provided at a predetermined or user-configurable time each day (e.g., after the user's work day has ended or at the start of the user's day). In another example, the notification may be provided in response to an identified event, such as a user requesting that a computing device be shut down. It will be appreciated that any of a variety of user experience paradigms may be used to present such information, an example of which is provided below with respect to FIG. 5. Method 400 may terminate at operation 412. As another example, operation 412 may be performed independently from operations 406-408, such that operations 406-408 are performed even after operation 412 has been performed.

FIGS. 5A-5C illustrate overviews of example user interfaces with which sustainability information, a device utilization metric, and/or one or more configuration recommendations may be presented to a user. As illustrated, in FIG. 5A, user interface 500 is part of a settings user interface, but it will be appreciated that similar aspects may be used for any of a variety of other presentation mechanisms.

User interface 500 includes sustainability utilization metrics 510, configuration recommendations 504 and 506, and sustainability display 502. As illustrated, sustainability utilization metrics 510 include an associated estimated resource utilization for a computing device (e.g., “2 kg” for “7 day carbon emissions”) and an estimated resource conservation (e.g., “0.098 kg” of “7 day carbon savings (local)” and “56.7 kg” of “7 day carbon savings (global)”). With reference to configuration recommendation 504, user interface 500 includes recommendation icon 504A, recommendation text 504B, and reject user interface element 504C. For example, recommendation 504A may be provided to signal to a user that recommendation text 504B is provided as a configuration recommendation, the actuation of which will update a device configuration accordingly. By contrast, actuating reject user interface element 504C may reject the configuration recommendation, such that configuration recommendation 504 may be omitted from user interface 500. In examples, configuration recommendation 504 may be presented to a user at a later time, for example using a similar or a different presentation mechanism as described above. Aspects of configuration recommendation 506 are similar to configuration recommendation 504 and are therefore not necessarily re-described.

Turning to sustainability display 502, the display includes historical device utilization metric display 502A and sustainability forecast display 502C. Displays 502A and 502C are separated by divider 502B, which provides a graphical separation between historical data (e.g., based on observed device energy consumption) and future data (e.g., based on a sustainability forecast). Divider 502B may move according to the system time of the device, such that a forecast entry transitions to a sustainability utilization metric as a result of time progressing (e.g., such that divider 502B advances to the left of user interface 500). Thus, an estimated past environmental impact of the device is presented by display 502A (e.g., to the left of divider 502B), while a user may view a part of a sustainability forecast via display 502C (e.g., to the right of divider 502B). Display 502C includes region 508, which indicates a time period having a comparatively lower estimated impact as compared to other times. Thus, display 502C may graphically convey one or more time periods during which device utilization is estimated to have a comparatively lower impact. As illustrated, display 502 is segmented on an hourly basis for a 24-hour period, but it will be appreciated that any of a variety of other time periods and associated segmentations may be used in other examples. For instance, these and other aspects of the generated visualization may be user-configurable.

Turning to FIG. 5B, example user interface 530 is provided as an example display in which an “eco settings score” is presented to a user. Aspects of user interface 530 may be similar to those of user interface 500 and are therefore not necessarily re-described below in detail. Settings score 532 may be generated based on a device configuration, as may be evaluated according to a set of conservation rules according to aspects described herein. In examples, settings score 532 may be updated in response to a configuration change of a device (e.g., as may result from a user acceptance of a configuration recommendation or user input received by a settings user interface, among other examples).

FIG. 5C provides another example user interface 570 including local impact 572 and global impact 574. Aspects of user interface 570 may be similar to those of user interface 500 and are therefore not necessarily re-described below in detail. As noted in FIG. 5C, local impact 572 provides an estimated savings for a device on which user interface 570 is displayed. Similarly, global impact 574 provides an estimated savings for a group of devices. In examples, the estimated savings of local impact 572 and/or global impact 574 may be based at least in part on one or more associated peripheral devices.

It will be appreciated that any of a variety of additional or alternative metrics may be displayed in other examples. For example, a first global metric may be presented for a first set of devices associated with a user, while a second global metric may be presented for a second set of devices associated with a group of users (e.g., in a household or in an organization). In examples, such aspects may be user-configurable, for example to enable a user to select a subset of devices from a set of available devices.

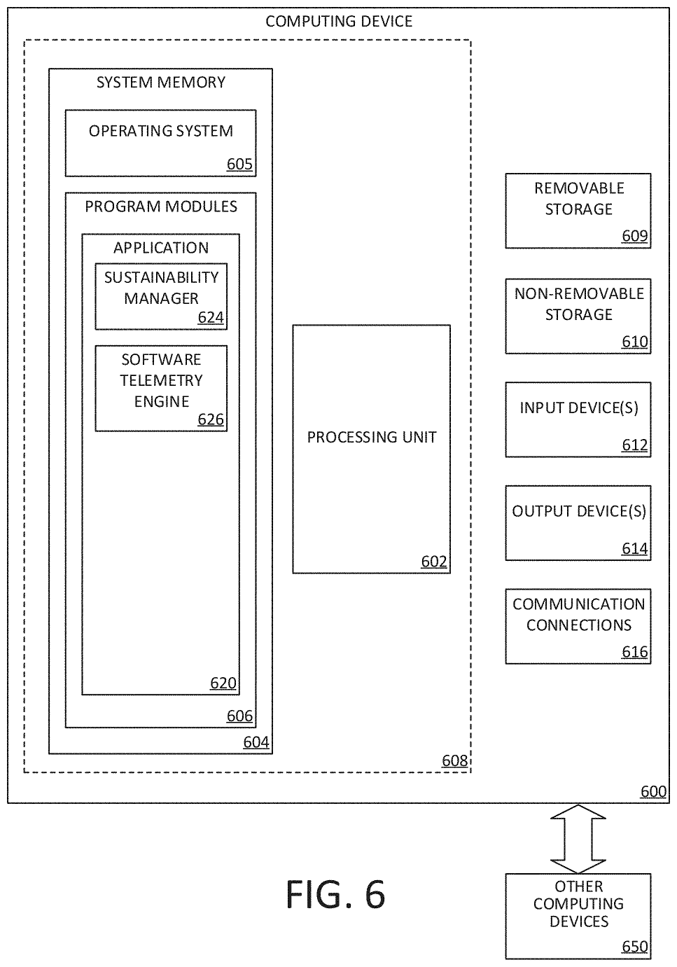

FIGS. 6-9 and the associated descriptions provide a discussion of a variety of operating environments in which aspects of the disclosure may be practiced. However, the devices and systems illustrated and discussed with respect to FIGS. 6-9 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including devices 102 and 104 in FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store sustainability manager 624 and software telemetry engine 626. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

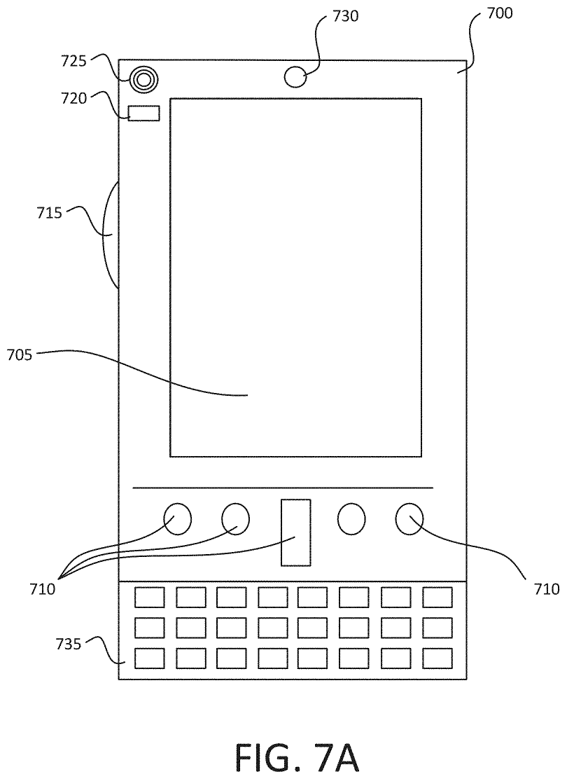

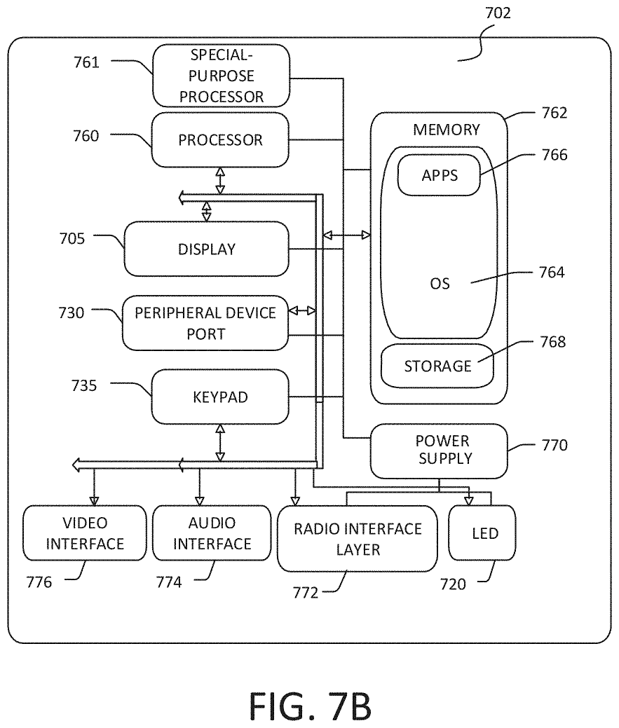

FIGS. 7A and 7B illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display).

If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments.

In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display.

In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein (e.g., a sustainability manager, a software telemetry engine, etc.).

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

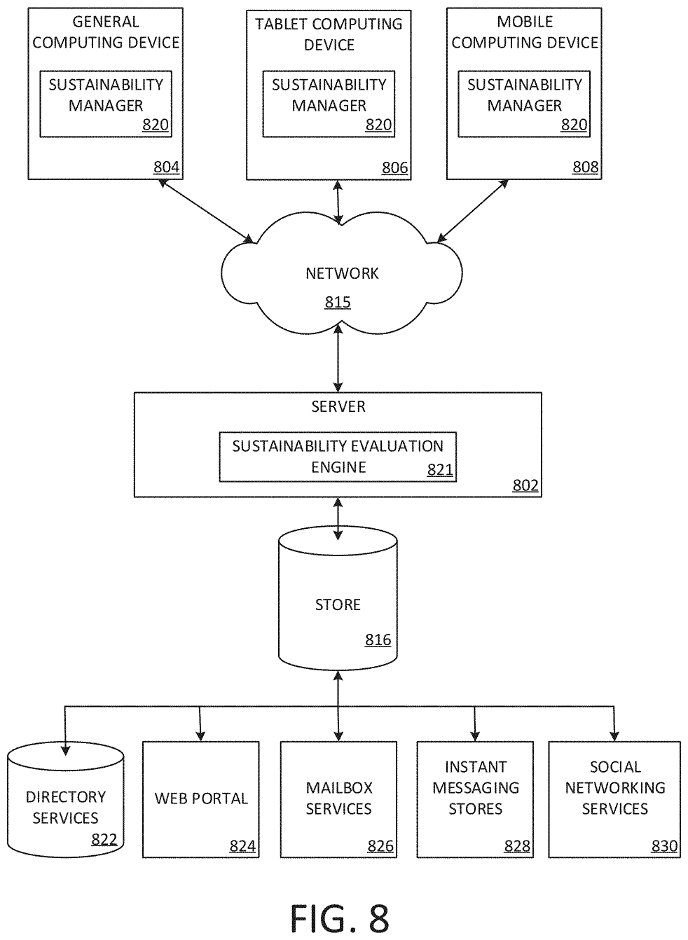

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 822, a web portal 824, a mailbox service 826, an instant messaging store 828, or a social networking site 830.

A sustainability manager 820 may be employed by a client that communicates with server device 802, and/or sustainability evaluation engine 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these embodiments of the computing devices may obtain content from the store 816, in addition to receiving graphical data useable to be either pre-processed at a graphic-originating system, or post-processed at a receiving computing system.

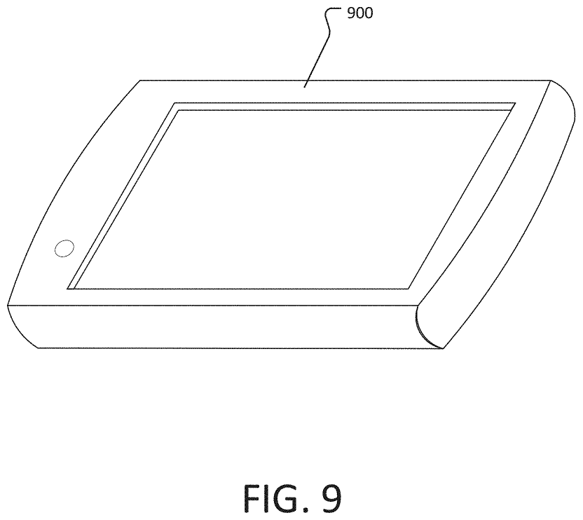

FIG. 9 illustrates an exemplary tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: obtaining, based on a sustainability platform, a configuration recommendation associated with a configuration option of the system, wherein the configuration recommendation is associated with an environmental impact of the system; presenting, to a user of the system, an indication of the configuration recommendation, wherein the indication includes a user interface element to accept the configuration recommendation; and when user actuation of the user interface element is received, modifying the configuration option of the system according to the configuration recommendation. In an example, obtaining the configuration recommendation comprises: providing, to the sustainability platform, telemetry data associated with the system; and receiving, from the sustainability platform, the configuration recommendation based on the provided telemetry data. In another example, obtaining the configuration recommendation comprises: obtaining, from the sustainability platform, a set of conservation rules associated with the system; and processing telemetry data of the system according to the set of conservation rules to generate the configuration recommendation. In a further example, the set of operations further comprises: obtaining, from the sustainability platform, a second configuration recommendation associated with the environmental impact of the system; presenting, to the user, a first indication of the second configuration recommendation; receiving user input associated with the first indication to reject the second configuration recommendation; and in response to the received user input, presenting a second indication of the second configuration recommendation. In yet another example, the first indication is one of: an indication on a lock screen of the system; a notification to the user; or an indication via a settings user interface. In a further still example, the second indication is different from the first indication. In an example, the indication further comprises: text associated with the configuration recommendation; and a second user interface element to reject the configuration recommendation.

In another aspect, the technology relates to a method for generating a sustainability utilization metric associated with a computing device. The method comprises: obtaining a sustainability forecast associated with the computing device, wherein the sustainability forecast is for a predetermined time period; determining a device utilization for a time segment of the time period; generating the sustainability utilization metric based on the determined device utilization and a sustainability forecast entry of the sustainability forecast corresponding to the time segment; and presenting, to a user of the computing device, an indication of the generated sustainability utilization metric. In an example, the generated sustainability utilization metric is presented in conjunction with at least a part of the sustainability forecast. In another example, the indication includes a divider and the generated sustainability utilization metric is presented on a first side of the divider and the part of the sustainability forecast is presented on a second side of the divider. In a further example, the determined device utilization includes an energy consumption of the computing device during the time segment and the sustainability forecast entry includes an estimated environmental impact associated with energy consumption. In yet another example, obtaining the sustainability forecast comprises: providing, to a sustainability platform, a sustainability forecast request; and receiving, from the sustainability platform, the sustainability forecast request for an energy grid associated with the computing device. In a further still example, the indication of the generated sustainability utilization metric is presented as one of: an indication on a lock screen of the computing device; a notification to the user; or an indication via a settings user interface.

In a further aspect, the technology relates to a method for configuring a computing device according to a configuration recommendation. The method comprises: obtaining, based on a sustainability platform, the configuration recommendation associated with a configuration option of the computing device, wherein the configuration option is associated with an environmental impact of the computing device; presenting, to a user, an indication of the configuration recommendation, wherein the indication includes a user interface element to accept the configuration recommendation; and in response to a user actuation of the user interface element, modifying the configuration option according to the configuration recommendation. In an example, obtaining the configuration recommendation comprises: providing, to the sustainability platform, telemetry data associated with the computing device; and receiving, from the sustainability platform, the configuration recommendation based on the provided telemetry data. In another example, obtaining the configuration recommendation comprises: obtaining, from the sustainability platform, a set of conservation rules associated with the system; and processing telemetry data of the computing device according to the set of conservation rules to generate the configuration recommendation. In a further example, the method further comprises: obtaining, from the sustainability platform, a second configuration recommendation; presenting, to the user, a first indication of the second configuration recommendation; receiving user input associated with the first indication to reject the second configuration recommendation; and in response to the received user input, presenting a second indication of the second configuration recommendation. In yet another example, the first indication is one of: an indication on a lock screen of the system; a notification to the user; or an indication via a settings user interface. In a further still example, the second indication is different from the first indication. In another example, the indication further comprises: text associated with the configuration recommendation; and a second user interface element to reject the configuration recommendation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system comprising:
at least one processor; and
memory storing instructions that, when executed by the at least one processor, causes the system to perform a set of operations, the set of operations comprising:
obtaining, based on a sustainability platform, a configuration recommendation associated with a configuration option of the system, wherein the configuration recommendation is associated with an environmental impact of the system;
presenting, to a user of the system, an indication of the configuration recommendation, wherein the indication includes a user interface element to accept the configuration recommendation; and
when user actuation of the user interface element is received, modifying the configuration option of the system according to the configuration recommendation.

2. The system of claim 1, wherein obtaining the configuration recommendation comprises:
providing, to the sustainability platform, telemetry data associated with the system; and
receiving, from the sustainability platform, the configuration recommendation based on the provided telemetry data.

3. The system of claim 1, wherein obtaining the configuration recommendation comprises:
obtaining, from the sustainability platform, a set of conservation rules associated with the system; and
processing telemetry data of the system according to the set of conservation rules to generate the configuration recommendation.

4. The system of claim 1, wherein the set of operations further comprises:
obtaining, from the sustainability platform, a second configuration recommendation associated with the environmental impact of the system;
presenting, to the user, a first indication of the second configuration recommendation;
receiving user input associated with the first indication to reject the second configuration recommendation; and
in response to the received user input, presenting a second indication of the second configuration recommendation.

5. The system of claim 4, wherein the first indication is one of:
an indication on a lock screen of the system;
a notification to the user; or
an indication via a settings user interface.

6. The system of claim 5, wherein the second indication is different from the first indication.

7. The system of claim 1, wherein the indication further comprises:
text associated with the configuration recommendation; and
a second user interface element to reject the configuration recommendation.

8. A method for generating a sustainability utilization metric associated with a computing device, the method comprising:
obtaining a sustainability forecast associated with the computing device, wherein the sustainability forecast is for a predetermined time period;
determining a device utilization for a time segment of the time period;
generating the sustainability utilization metric based on the determined device utilization and a sustainability forecast entry of the sustainability forecast corresponding to the time segment; and
presenting, to a user of the computing device, an indication of the generated sustainability utilization metric.

9. The method of claim 8, wherein the generated sustainability utilization metric is presented in conjunction with at least a part of the sustainability forecast.

10. The method of claim 9, wherein the indication includes a divider and the generated sustainability utilization metric is presented on a first side of the divider and the part of the sustainability forecast is presented on a second side of the divider.

11. The method of claim 8, wherein the determined device utilization includes an energy consumption of the computing device during the time segment and the sustainability forecast entry includes an estimated environmental impact associated with energy consumption.

12. The method of claim 8, wherein obtaining the sustainability forecast comprises:
providing, to a sustainability platform, a sustainability forecast request; and
receiving, from the sustainability platform, the sustainability forecast request for an energy grid associated with the computing device.

13. The method of claim 8, wherein the indication of the generated sustainability utilization metric is presented as one of:
an indication on a lock screen of the computing device;
a notification to the user; or
an indication via a settings user interface.

14. A method for configuring a computing device according to a configuration recommendation, the method comprising:
obtaining, based on a sustainability platform, the configuration recommendation associated with a configuration option of the computing device, wherein the configuration option is associated with an environmental impact of the computing device;
presenting, to a user, an indication of the configuration recommendation, wherein the indication includes a user interface element to accept the configuration recommendation; and
in response to a user actuation of the user interface element, modifying the configuration option according to the configuration recommendation.

15. The method of claim 14, wherein obtaining the configuration recommendation comprises:
providing, to the sustainability platform, telemetry data associated with the computing device; and
receiving, from the sustainability platform, the configuration recommendation based on the provided telemetry data.

16. The method of claim 14, wherein obtaining the configuration recommendation comprises:
obtaining, from the sustainability platform, a set of conservation rules associated with the system; and
processing telemetry data of the computing device according to the set of conservation rules to generate the configuration recommendation.

17. The method of claim 14, further comprising:
obtaining, from the sustainability platform, a second configuration recommendation;
presenting, to the user, a first indication of the second configuration recommendation;
receiving user input associated with the first indication to reject the second configuration recommendation; and
in response to the received user input, presenting a second indication of the second configuration recommendation.

18. The method of claim 17, wherein the first indication is one of:
an indication on a lock screen of the system;
a notification to the user; or
an indication via a settings user interface.

19. The method of claim 18, wherein the second indication is different from the first indication.

20. The method of claim 14, wherein the indication further comprises:
text associated with the configuration recommendation; and
a second user interface element to reject the configuration recommendation.
